(19) United States
(12) Patent Application Publication
(10) Pub. No.: US 2015/0081159 A1
(43) Pub. Date: Mar. 19, 2015

(54) APPARATUS AND METHOD OF SENSING AND CONTROLLING WEAR OF BRAKE LINING

(71) Applicants: HYUNDAI MOTOR COMPANY, Seoul (KR); DAESUNG ELECTRIC CO., LTD., Seoul (KR); KIA MOTORS CORPORATION, Seoul (KR)

(72) Inventors: Sung Su Park, Iksan (KR); Jae Yun Park, Ansan (KR); Young Sik Cho, Ansan (KR)

(73) Assignees: HYUNDAI MOTOR COMPANY, Seoul (KR); DAESUNG ELECTRIC CO., LTD., Ansan, Gyeonggi-Do (KR); KIA MOTORS CORPORATION, Seoul (KR)

(21) Appl. No.: 14/107,496

(22) Filed: Dec. 16, 2013

(30) Foreign Application Priority Data
Sep. 17, 2013 (KR) 10-2013-0111608

(51) Int. Cl. B60T 17/22

(52) U.S. Cl. CPC B60T 17/221
USPC 701/29.4

(57) ABSTRACT

An apparatus and method of sensing and controlling wear of a brake lining, whereby wear of the brake lining is sensed so that equal wear of the brake lining can be carried out by an electronic braking system. That is, in the apparatus and method of sensing and controlling wear of each brake lining displays the remaining amount of wear and a projected replacement time for the brake lining on a display of a cluster based on a signal obtained by sensing wear of each brake lining and simultaneously brake lining wear of each wheel is provided to an electronics brake system so that an appropriate braking force for each brake lining of each wheel can be carried out by the electronics brake system.

### CROSS-REFERENCE TO RELATED PATENT APPLICATION

This application claims the benefit of Korean Patent Application No. 10-2013-0111608, filed on Sep. 17, 2013 in the Korean Intellectual Property Office, the disclosure of which is incorporated herein in its entirety by reference.

### BACKGROUND OF THE INVENTION

1. Field of the Invention

The present invention relates to an apparatus and method of sensing and controlling wear of a brake lining, and more particularly, to an apparatus and method of sensing and controlling wear of a brake lining, whereby wear of the brake lining is sensed so that equal wear of the brake lining can be carried out.

2. Description of the Related Art

As a brake is often repeatedly applied and operated during driving of a vehicle, the brake lining on the brake pads is gradually worn down as a result. Thus, the brake lining should be replaced at an appropriate time so as to maintain brake proper performance.

Since the surface of the brake lining cannot be easily inspected from an outside of the vehicle, it is difficult for a driver to check the wear state of the brake lining unless the driver is a professional vehicle mechanic. As a result, a replacement time caused by wear of the brake lining cannot be accurately detected and thus, the vehicle owners often miss an appropriate replacement time for the brake lining.

One way of solving this problem has been to utilize a lining sensor for sensing wear of a brake lining that warns a driver of the amount of wear and a replacement time for the brake lining based on a sensing signal of a lining sensor.

However, in these systems, when the brake lining is worn down, the system merely informs the driver of wear of the brake lining using a warning lamp or an alarm sound, and the remaining amount of wear of the brake lining cannot be accurately conveyed to the driver.

In particular, these sensing devices do not respond to when one-sided wear occurs between brake linings mounted on several wheels of the vehicle, i.e., when the brake linings each have different amounts of wear even when they are all replaced at the same time. Thus, a replacement period for the brake linings becomes irregular, and the wear state of each brake lining cannot be maintained at a level at which brake performance can be optically carried out.

### SUMMARY OF THE INVENTION

The present invention provides an apparatus and method of sensing and informing a user of the wear of a brake lining. In particular, a controller, including a processor and a memory, is configured to display the remaining amount of wear and a replacement time for a particular brake lining on a display of a cluster based on a signal obtained by sensing wear of the particular brake lining and simultaneously provide brake lining wear of each wheel configuration (i.e., the wheel, brake pad and rotor) to an electronics brake system so that equal lining wear of each wheel configuration can be carried out by the electronics brake system.

According to an aspect of the present invention, there is provided an apparatus for sensing and controlling wear of a brake lining, the apparatus. In particular, a brake lining wear sensor is mounted on each wheel of a vehicle and senses wear of the brake lining. In communication with each of the sensors is a brake lining wear sensor controller that receives a wear sensing signal from each of the brake lining wear sensors in real-time and provides wear information of each brake lining within a cluster display in the interior of the vehicle and an electronics brake system. The cluster that displays the remaining amount of wear of the brake lining and a replacement time for the brake lining is based on the lining wear information received from the brake lining wear sensor controller. The electronics brake system equally controls wear of brake linings mounted on several wheels based on the lining wear information from the brake lining wear sensor controller as a result.

As such, the brake lining wear sensor controller may include: a power input adaptor connected to battery power; a power controller that is connected to the power input unit, supplies power of about 5V into the brake lining wear sensor controller and supplies source power to the brake lining wear sensor; a microcomputer (e.g., processor) that performs information processing related to lining wear; a sensor voltage input adaptor that receives a voltage corresponding to the remaining amount of wear of the brake lining from the brake lining wear sensor and transmits the voltage to the microcomputer; and a Controller Area Network (CAN) communication unit that transmits the lining wear information processed by the microcomputer to the electronics brake system.

Additionally, in some exemplary embodiments of the present invention, the brake lining wear sensor controller may further include a diagnostic switch input adaptor that allows connection of diagnostic equipment for maintenance to be connected to the microcomputer, and/or a light emitting diode (LED) output unit that outputs a warning signal in non-communication specifications.

According to another aspect of the present invention, there is provided a me nod of sensing and controlling wear of a brake lining, the method including: sensing wear of a brake lining mounted on each wheel of a vehicle using a brake lining wear sensor; receiving a wear sensing signal associated with the brake lining from a brake lining wear sensor controller and performing an arithmetic operation on (i.e., determining) the remaining amount of wear caused by wear of the brake lining and a replacement time for the brake lining; informing a driver of the remaining amount of wear and replacement time for the brake lining using a cluster; and when there is a difference in wear of brake linings, equally controlling wear of the brake linings by an electronics braking system.

The equally controlling of wear of the brake linings may include: receiving wear information related to each brake lining from the brake lining wear sensor controller; and when there is a difference in wear of the brake linings, controlling a braking force of each wheel using the electronics brake system to equally control the wear of the brake linings.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the configuration of an apparatus for sensing and controlling wear of a brake lining according to an exemplary embodiment of the present invention; and

FIG. 2 illustrates the configuration of a brake lining wear sensor controller of the apparatus for sensing and controlling wear of a brake lining illustrated in FIG. 1.

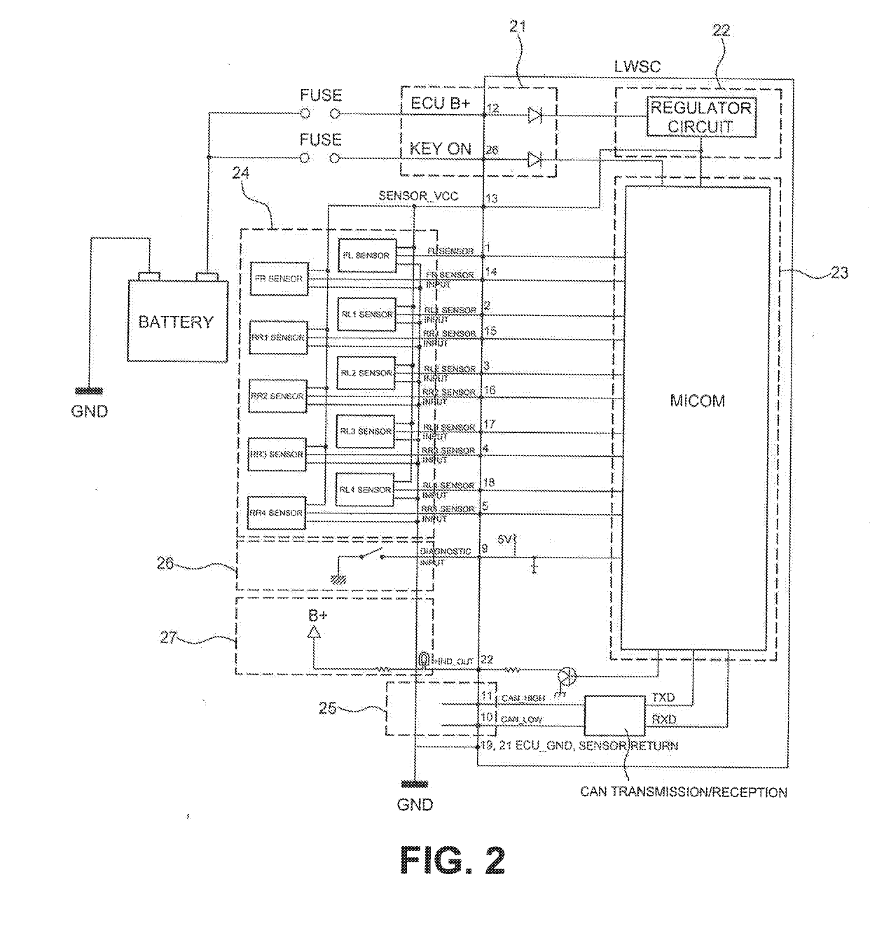

### DETAILED DESCRIPTION OF THE INVENTION

The present invention will now be described more fully with reference to the accompanying drawings, in which exemplary embodiments of the invention are shown.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric, vehicles, combustion, plug-in hybrid electric vehicles, hydrogen-powered vehicles, fuel cell vehicles, and other alternative fuel vehicles (e.g., fuels derived from resources other than petroleum).

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

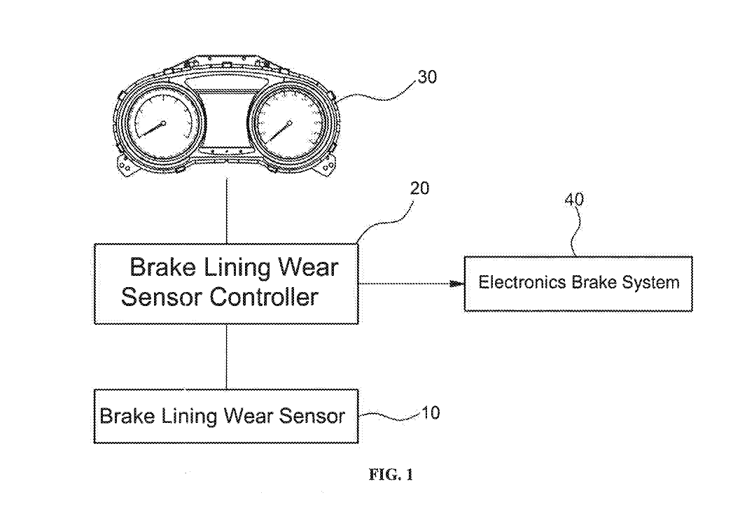

In relation to the exemplary embodiment of the present invention, numeral 10 of FIG. 1 represents a brake lining wear sensor that is configured to sense wear of a brake lining from among elements of a braking device mounted on each wheel of a vehicle. The brake lining wear sensor 10 is mounted on wheels (e.g., wheels of a vehicle or trailer) of the vehicle, senses wear of the brake lining in real-time and transmits a sensed voltage signal to a brake lining wear sensor controller 20.

The brake lining wear sensor controller 20 receives and processes the wear sensing signal of the brake lining wear sensor 10 in real-time and then provides wear information of each brake lining required to a cluster 30 and an electronics brake system (EBS) 40. The brake lining wear sensor controller 20 includes a power input adaptor 21 to which power is supplied so as to perform a series of operations and a power controller 22 that distributes and provides power suitable for each electrical operating element within the brake lining wear sensor controller 20.

In this case, the power input adaptor 21 receives power from a battery and a first ignition signal IGN1 (i.e., “KEY ON” signal in FIG. 1) of an ignition key box so as to perform an operation of the brake lining wear sensor controller 20, and the power controller 22 is connected to the power input adaptor 21, provides power of about 5V into the brake lining wear sensor controller 20 and simultaneously supplies source power to the brake lining wear sensor 10.

Also, the brake lining wear sensor controller 20 may include a sensor voltage input adaptor 24 that receives a voltage sensing signal corresponding to the remaining amount of wear of the brake lining from the brake lining wear sensor 10 and transmits the voltage sensing signal to a microcomputer (MICOM) (e.g., processor) 23. The microcomputer (MICOM) 23 performs an arithmetic operation on (process execution/determining) information (e.g., wear of lining, the remaining amount of wear of lining, and a replacement time for a lining) regarding lining wear based on the voltage sensing signal received through the sensor voltage input adaptor 24, as input elements.

The information (e.g., wear of lining, the remaining amount of wear of lining, and a replacement time for a lining) on which the arithmetic operation is performed by the MICOM 23 of the brake lining wear sensor controller 20, is transmitted to the cluster 30 that may be disposed in front of a driver's seat and the electronics brake system (EBS) 40 that distributes and controls braking forces of wheels through a CAN communication adaptor 25 within the brake lining wear sensor controller 20.

The cluster 30 receives the lining wear information from the brake lining wear sensor controller 20 and displays the remaining amount of wear of the brake linings of each of the wheels individual and a replacement times thereof. In particular, the EBS 40 receives the brake lining wear information from the brake lining wear sensor controller 20 and performs braking force distribution control on each wheel respectively during braking so as to equally control wear of brake linings mounted on wheels.

The brake lining wear sensor controller 20 may further includes a diagnostic switch input adaptor 26 that allows connection of diagnosis equipment for maintenance to be connected to the MICOM 23 and a light emitting diode (LED) output unit 27 that outputs a warning signal in non-communication specifications.

The diagnostic switch input adaptor 26 informs the MICOM 23 that additional external diagnostic equipment is connected to the brake lining wear sensor controller 20 in order to inspect the brake lining wear sensor controller 20 in addition to the brake lining wear sensor(s) 10. When the diagnostic equipment is connected to the brake lining wear sensor controller 20 for diagnosis by a professional vehicle mechanic, storage information (e.g., an abnormal output range of a sensor, break and short circuit of the sensor, and malfunction diagnostic information of a controller itself) of the MICOM 23 can be transmitted to the diagnostic equipment.

The LED output unit 27 is configured to turn on a warning lamp mounted on the cluster 30 so as to give warning to the driver due to the lining wear information (for example, when wear is at a predetermined level or more) in case of non-communication specifications in which the lining wear information cannot be transmitted to the cluster 30 or the EBS 40 through can communication. In a Lining Wear Sensor (LWS), for example, “communication specifications” refer to transferring a signal to turn on/off a warning lamp from a control unit (LWS controller) into a cluster via a CAN communication signal. In particular, specifications where the cluster is unable to receive the CAN communication signal is called “non-communication specifications”. In the case of non-communication specifications, the LWS should directly turn on the warning lamp in the cluster via a wire signal. That is, the “communication specifications” and “non-communication specifications” are determined based on the way the signal is being transferred, either a communication method or a non-communication method.

In detail, in the “communication specifications”, a meaningful signal is sent out to a lamp unit where the signal is analyzed whether or not to turn on the lamp. In contrast, in the “non-communication specifications”, only a simple “On/Off” signal instead of a meaningful signal is sent out via wire, and the lamp unit simply turns on/turns off according to the signal being received. Here, a method of sensing and controlling wear of a brake lining using the above-described configuration, according to an exemplary embodiment of the present invention will be described below.

First, after the ignition key is turned on so as to start the vehicle, if the power of the battery and the first ignition signal IGN1 of the ignition key box are received from the power input adaptor 21 of the brake lining wear sensor controller 20, an operation of the brake lining wear sensor controller 20 starts being performed.

The brake lining wear sensor controller 20 performs inspection of elements of the brake lining wear sensor 10 (e.g., the brake pads and/or rotors) and the brake lining wear sensor controller 20 upon initiating the brake lining wear sensor controller 20. That is, when an output of the brake lining wear sensor 10 exceeds a predetermined range, or when diagnosis for break and short circuit of the brake lining wear sensor 10 in which signal input/output cannot be performed, a battery short and/or malfunction of the brake lining wear sensor controller 20 itself is performed and there is an abnormality, a warning lamp turn-on signal is transmitted to the cluster 30 so as to turn off an indicator, and if there is no abnormality as a diagnostic result, a series of operations related to lining wear are performed.

During general operation, wear of the brake lining mounted on each wheel of the vehicle is sensed by the brake lining wear sensor 10 and is transmitted to the brake lining wear sensor controller 20 on a regular, periodic or continuous basis, and the brake lining wear sensor controller 20 receives sensor information in the form of an analog voltage, processes/interprets the sensor information and then transmits the sensor information to the cluster 30 through the CAN communication adaptor 25. That is, the brake lining wear sensor controller 20 receives a wear sensing signal of the brake lining mounted on each wheel from the brake lining wear sensor 10, performs an arithmetic operation on the remaining amount of wear and a projected replacement time caused by wear of each lining and then transmits a signal indicating the result of the arithmetic operation to the cluster 30. Thus, the cluster 30 displays the remaining amount of wear of each lining and the projected replacement time thereof thereby informing the driver of the remaining amount of wear of each lining and the projected replacement time thereof.

In this case, if a value of the analog voltage from the brake lining wear sensor 10 is equal to or greater than a predetermined value, the brake lining wear sensor controller 20 interprets the value, calculates that the value is close to full wear, and transmits the result of calculation to the cluster 30. Then, the cluster 30 turns on the indicator that indicates the replacement time of the lining.

In this way, detailed information, such as the remaining amount of wear and the projected replacement time, in addition to wear of the brake lining mounted on the entire wheel (shaft) of the vehicle, is provided to the driver so that reliability and productivity of a braking device of the vehicle can be improved and the driver can know when is the proper time to replace the brake pads accordingly and thus driver's conveniences can be increased.

While braking is performed during driving of the vehicle, the brake lining wear sensor controller 20 transmits wear information of each brake lining to the EBS 40 that is a brake controller, in a resolution information unit of about 0.4%. In this case, when there is a difference in wear of brake linings, the EBS 40 controls wear of the brake linings equally.

In more detail, if the EBS 40 receives wear of each brake lining from the brake lining wear sensor controller 20 and if it is determined that there is a difference in wear of the brake linings, the EBS 40 performs distribution control (e.g., control to distribute a decreased braking force to a lining having severe wear and to distribute more braking force to a lining having less severe wear) of braking forces of each wheel so that wear of brake linings can be equally controlled.

In this way, information (information obtained by calculating wear of each brake lining in a percentage unit (e.g., about 0.4% unit)) regarding wear of each brake lining is provided to the EBS 40 so that braking force distribution control of the EBS 40 of each wheel can be performed, and one-sided wear in which only either one of brake linings is more worn down, can be prevented and simultaneously uniform wear of the brake linings can be induced.

As described above, the present invention provides the following effects.

First, in contrast to an apparatus for sensing wear of a lining according to the related art in which wear of a lining of a limited wheel can be sensed, detailed information, such as the amount of wear of brake linings mounted on the entire wheel (shaft) of a vehicle, the remaining amount of wear and a projected replacement time for the brake linings, can be provided to a driver so that an accident caused by a reduced of a braking force and malfunction of a braking device can be prevented.

Second, information (i.e., information obtained by calculating wear of each brake lining in a percentage unit (e.g., about 0.4% unit)) regarding wear of each brake lining is provided to an electronics brake system so as to perform control on the associated brake linings to differently set braking forces of the electronics brake system with respect to each wheel so that one-sided wear in which only one of brake linings is more worn down, can be prevented and simultaneously uniform wear of the brake linings can be induced.

Third, the remaining amount of wear and a projected replacement time in addition to wear of brake linings are displayed on a display of a cluster so that productivity can be improved and the driver plan maintenance for the vehicle in a more timely manner, thus driver's conveniences can be increased.

Fourth, when a lining wear sensor malfunctions, diagnostic equipment is connected to a brake lining wear sensor controller so that the state of a sensor can be immediately checked to easily maintain the sensors.

While the present invention has been particularly shown and described with reference to exemplary embodiments thereof it will be understood by those of ordinary skill in the art that various changes in form and details may be made therein without departing from the spirit and scope of the present invention as defined by the following claims.

What is claimed is:

1. An apparatus for sensing and controlling wear of a brake lining, the apparatus comprising:
a brake lining wear sensor mounted on each wheel of a vehicle that each sense wear of the brake lining of each wheel respectively;
a brake lining wear sensor controller configured to receive a wear sensing signal from each brake lining wear sensor in real-time and provide wear information of each brake lining;
a cluster that displays a remaining amount of wear for each the brake lining and a projected replacement time for each brake lining based on the wear information that is provided by the brake lining wear sensor controller; and
an electronics brake system that equally controls wear of each brake lining mounted on each of the wheels of the vehicle based on the wear information that is provided by the brake lining wear sensor controller.

2. The apparatus of claim 1, wherein the brake lining wear sensor controller comprises:
a power input adaptor connected to battery power;
a power controller that is connected to the power input adaptor, supplies power to the brake lining wear sensor controller and supplies source power to the brake lining wear sensor;
a processor that performs information processing related to brake lining wear;
a sensor voltage input adaptor that receives a voltage corresponding to the remaining amount of wear of each brake lining from each brake lining wear sensor respectively and transmits the voltage to the processor; and
a Controller Area Network (CAN) communication adaptor that transmits the wear information processed by the processor to the electronics brake system.

3. The apparatus of claim 2, wherein the brake lining wear sensor controller further comprises a diagnostic switch adaptor unit that allows connection of diagnostic equipment for maintenance to be connected to the microcomputer.

4. The apparatus of claim 2, wherein the brake lining wear sensor controller further comprises a light emitting diode (LED) output unit that outputs a warning signal in non-communication specifications.

5. A method of sensing and controlling wear of a brake lining, the method comprising:
sensing wear of a brake lining mounted on each wheel of a vehicle using a sensor;
receiving, at a controller, a wear sensing signal for each brake lining from each brake lining wear sensor and determining a remaining amount of wear caused by wear of the brake lining for each brake lining and a projected replacement time for each brake lining;
informing, by the controller, a driver of the remaining amount of wear and the projected replacement time for each brake lining using a cluster;
determining if there is a difference in wear between each brake lining; and
in response to determining that there is a difference in wear of brake linings, controlling a braking force of each wheel using the electronics brake system to equally control wear of the brake linings.

6. The method of claim 5, wherein the equally controlling of wear of the brake linings comprises:
receiving wear of each brake lining from the brake lining wear sensor controller at the electronics brake system; and
applying, by an electronic braking system, reduced braking force on brake linings with more wear and increased braking force on brake linings with less wear to equally wear the brake linings.

7. A non-transitory computer readable medium containing program instructions executed by a processor or controller, the computer readable medium comprising:
program instructions that receive a wear sensing signal for each brake lining at each wheel of a vehicle from a brake lining wear sensor at each wheel;
program instructions that determine a remaining amount of wear caused by wear of the brake lining for each brake lining and a projected replacement time for each brake lining;
program instructions that inform a driver of the remaining amount of wear and the projected replacement time for each brake lining using a cluster;
program instructions that determine if there is a difference in wear between each brake lining; and
program instructions that, in response to determining that there is a difference in wear of brake linings, control a braking force of each wheel to equally control wear of the brake linings.

8. The non-transitory computer readable medium of claim 7, wherein the program instructions that equally control wear of the brake linings receive wear of each brake lining from a brake lining wear sensor controller at an electronics brake system; and
apply reduced braking force on brake linings with more wear and increased braking force on brake linings with less wear to equally wear the brake linings.
